(19) United States
(12) Patent Application Publication
(10) Pub. No.: US 2018/0349794 A1
(43) Pub. Date: Dec. 6, 2018

(54) QUERY REJECTION FOR LANGUAGE UNDERSTANDING

(71) Applicant: INTEL IP CORPORATION, Santa Clara, CA (US)

(72) Inventors: Munir Nikolai Alexander Georges, Kehl (DE); Szymon Jessa, Gdansk (PL); Georg Stemmer, Munchen (DE)

(73) Assignee: INTEL IP CORPORATION, Santa Clara, CA (US)

(21) Appl. No.: 15/611,104

(22) Filed: Jun. 1, 2017

(51) Int. Cl. G06N 99/00; G06F 17/27; G10L 15/183; G10L 15/22; G06N 7/00

(52) U.S. Cl. CPC G06N 99/005; G06F 17/2785; G06N 7/005; G10L 15/22; G10L 15/183

(57) ABSTRACT

Techniques are provided for rejecting out-of-domain (OD) queries in a language understanding system. A methodology implementing the techniques according to an embodiment includes generating a plurality of in-domain (ID) utterances based on variations of provided ID sentences, and generating a plurality of OD utterances based on variations of provided OD sentences. The method may further include training an ID language model based on the generated ID utterances and training an OD language model based on the generated OD utterances. The ID language model is configured to generate an ID dataset based on calculated probabilities associated with the generated ID utterances. The OD language model is configured to generate an OD dataset based on calculated probabilities associated with the generated OD utterances. The method further includes training a classifier to detect OD queries from a plurality of received queries, the training based on the ID dataset and the OD dataset.

### BACKGROUND

Conversational computer systems typically have problems handling out-of-domain queries, that is to say, queries related to subject matter that is outside of the application or task for which the system is intended. This may occur, for example, when the user is not fully informed about the limitations of the system or when the user intentionally tries to confuse the system. For instance, a user may ask a food delivery system for travel advice. An out-of-domain query can also occur when the speech recognizer fails to recognize a complete sentence. If the system is unable to detect an out-of-domain query it typically misinterprets the sentence and gives a confusing response.

Detection of out-of-domain queries is generally difficult as there is no boundary to what a user can say to a system, and typically there are few or no sample utterances available for modeling out-of-domain queries. Previous attempts to solve this problem are generally based on speech recognition confidence values and thresholds, but determining these thresholds is an expensive and time-consuming process that requires extensive user testing. Additionally, speech recognition confidence values can be misleading, since a large vocabulary speech recognizer may accurately recognize words of a sentence even though the sentence is an out-of-domain query that will confuse the application.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts.

FIG. 1 is a top-level block diagram of an implementation of a query rejection system, configured in accordance with certain embodiments of the present disclosure.

FIG. 2 is a more detailed block diagram of the implementation and training of the query rejection system, configured in accordance with certain embodiments of the present disclosure.

FIG. 3 is a more detailed block diagram of the in-domain (ID) utterance generation circuit, configured in accordance with certain embodiments of the present disclosure.

FIG. 4 is a more detailed block diagram of the out-of-domain (OD) utterance generation circuit, configured in accordance with certain embodiments of the present disclosure.

FIG. 5 is a flowchart illustrating a methodology for training a query rejection system, in accordance with certain embodiments of the present disclosure.

FIG. 6 is a block diagram schematically illustrating a computing platform configured to perform query rejection for language understanding, in accordance with certain embodiments of the present disclosure.

Although the following Detailed Description will proceed with reference being made to illustrative embodiments, many alternatives, modifications, and variations thereof will be apparent in light of this disclosure.

### DETAILED DESCRIPTION

Generally, this disclosure provides techniques for training a query rejection system classifier to detect and reject out-of-domain queries to improve language understanding by a downstream language-based application such as, for example, an automobile navigation system or a smart-home management system. In-domain (e.g., task related) and out-of-domain (e.g., non-task related) queries are modeled using machine learning techniques, such as neural networks or conditional random fields. An automatic sentence generation system is configured to provide training samples for the machine learning system. The disclosed automatic sentence generation system applies intrinsic and extrinsic generalization techniques to a relatively small set of available in-domain (ID) and out-of-domain (OD) example sentences to synthesize a much larger data set of ID and OD sentences for training the query rejection classifier, as will be described in greater detail below.

The disclosed techniques can be implemented, for example, in a computing system or a software product executable or otherwise controllable by such systems, although other embodiments will be apparent. The system or product is configured to train a classifier to detect OD queries based on automated generation of ID and OD data sets. In accordance with an embodiment, a methodology to implement these techniques includes generating a plurality of in-ID utterances based on variations of one or more of a plurality of ID sentences. In some embodiments, the ID sentences may be provided from a database of task specific sentences or phrases. The method further includes generating a plurality of OD utterances based on variations of one or more of a plurality of OD sentences. In some embodiments, the OD sentences may be provided from a database of sentences or phrases that are unrelated to the task or application of interest. In some embodiments, the method further includes training an ID statistical language model based on the plurality of ID utterances and training an OD statistical language model based on the plurality of OD utterances. The language models are configured to generate ID and OD datasets, respectively, based on calculated probabilities associated with the plurality of ID and OD utterances. The method further includes training a classifier, based on the ID dataset and the OD dataset, to detect and/or reject received OD queries in an operational mode.

As will be appreciated, the techniques described herein may allow for improved language understanding based on rejection of OD queries, compared to existing methods that either fail to distinguish OD queries from ID queries or attempt to do so based on confidence recognition thresholds that are difficult to generate and generally less reliable. The disclosed techniques can be implemented on a broad range of platforms including laptops, tablets, smart phones, workstations, and embedded systems or devices. These techniques may further be implemented in hardware or software or a combination thereof.

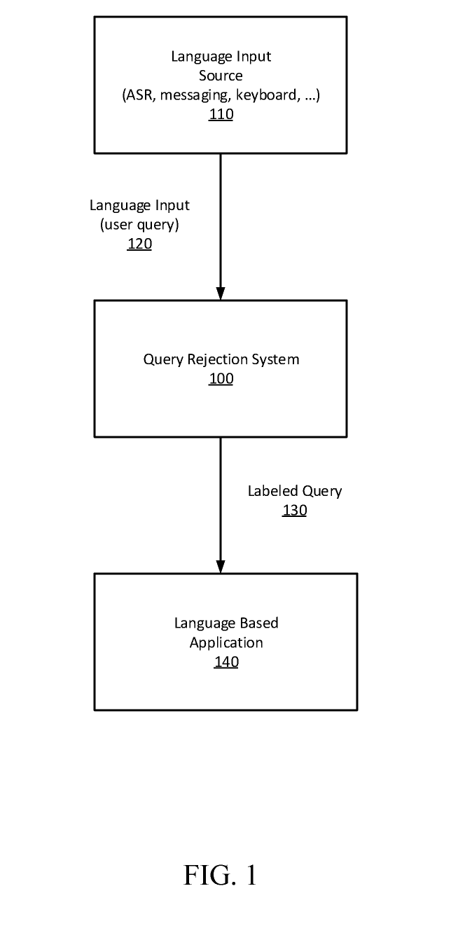

FIG. 1 is a top-level block diagram of an implementation of a query rejection system 100, configured in accordance with certain embodiments of the present disclosure. A language input source 110 is shown to provide user queries 120. In some embodiments, the language input source may be an automatic speech recognition (ASR) system, a messaging system, a keyboard, or any other suitable source. The user queries 120 are intended to be provided to a language-based application 140 which is configured to understand the query and potentially perform some action based on that understanding. One example of a language-based application is a voice controlled automobile climate system, for which the query might be “set temperature to 70 degrees.” Another example is a voice controlled automobile entertainment system, for which the query might be “skip to the next song.” Of course, many other examples are possible, such as a smart-home management system which could respond to a query such as “turn lights on in living room.” These are examples of in-domain or ID queries associated with their respective applications (climate control, entertainment, smart-home management). In contrast, an example of an out-of-domain or OD query would be a question about travel tips presented to a food delivery application.

Query rejection system 100 is shown to intercept the user queries 120 prior to transmission to the language-based application 140. The query rejection system 100 is configured to detect queries that are out of the domain of the application 140 and either reject them, so that they are not provided to the application, or label them as OD so that the application can handle them in a suitable manner. In some embodiments, an estimated OD probability may be provided to the application, as additional information or as an alternative to the binary labeling of OD versus ID. Some queries may be rejected as OD because the sentence was not fully recognized. The rejection allows the ASR to continue listening to the user, such that the user may remain unaware of the initial misinterpretation.

The query rejection system 100 employs a trained classifier to distinguish ID queries from OD queries. The training of the classifier and operation of the query rejection system 100 is described in greater detail below. In some embodiments, the query rejection system may also incorporate additional information such as ASR confidence thresholds, language model scores, and/or acoustic model scores to aid in the detection of OD queries.

It will be understood that in some embodiments, the terms “sentences,” “words,” and “utterances,” as used herein, may refer to data represented as a sequence of phonemes.

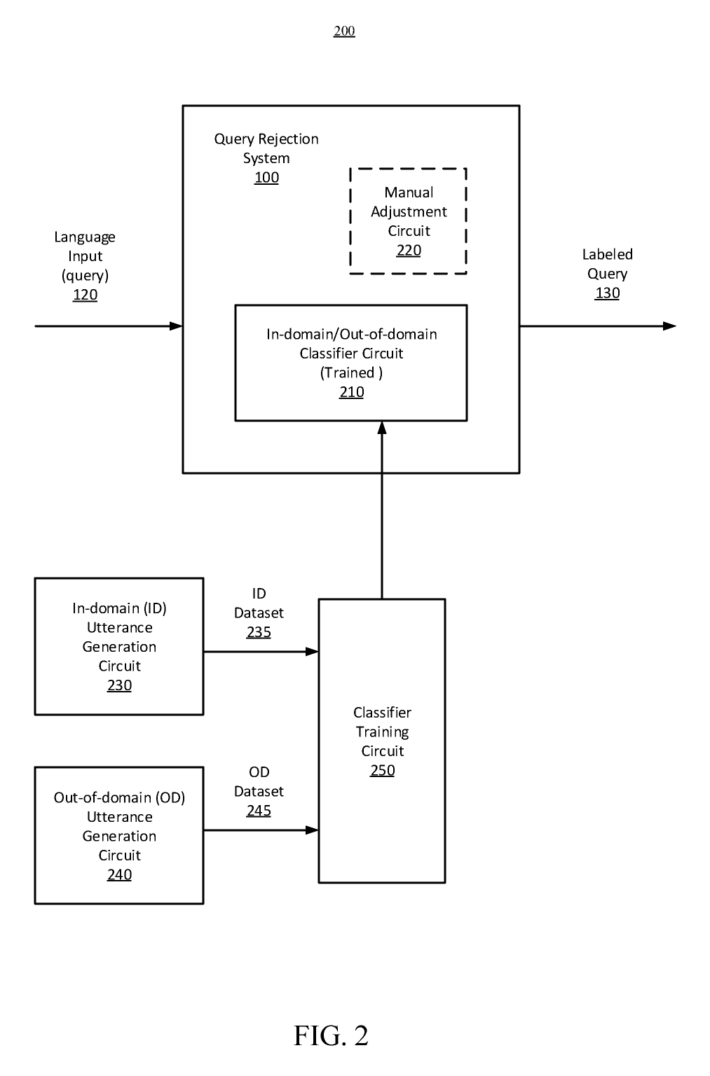

FIG. 2 is a more detailed block diagram 200 of the implementation and training of the query rejection system, configured in accordance with certain embodiments of the present disclosure. The query rejection system 100 is shown to include an ID/OD classifier circuit 210 and an optional manual adjustment circuit 220. Also shown is an ID utterance generation circuit 230, an OD utterance generation circuit 240, and a classifier training circuit 250 which is configured to train the ID/OD classifier 210.

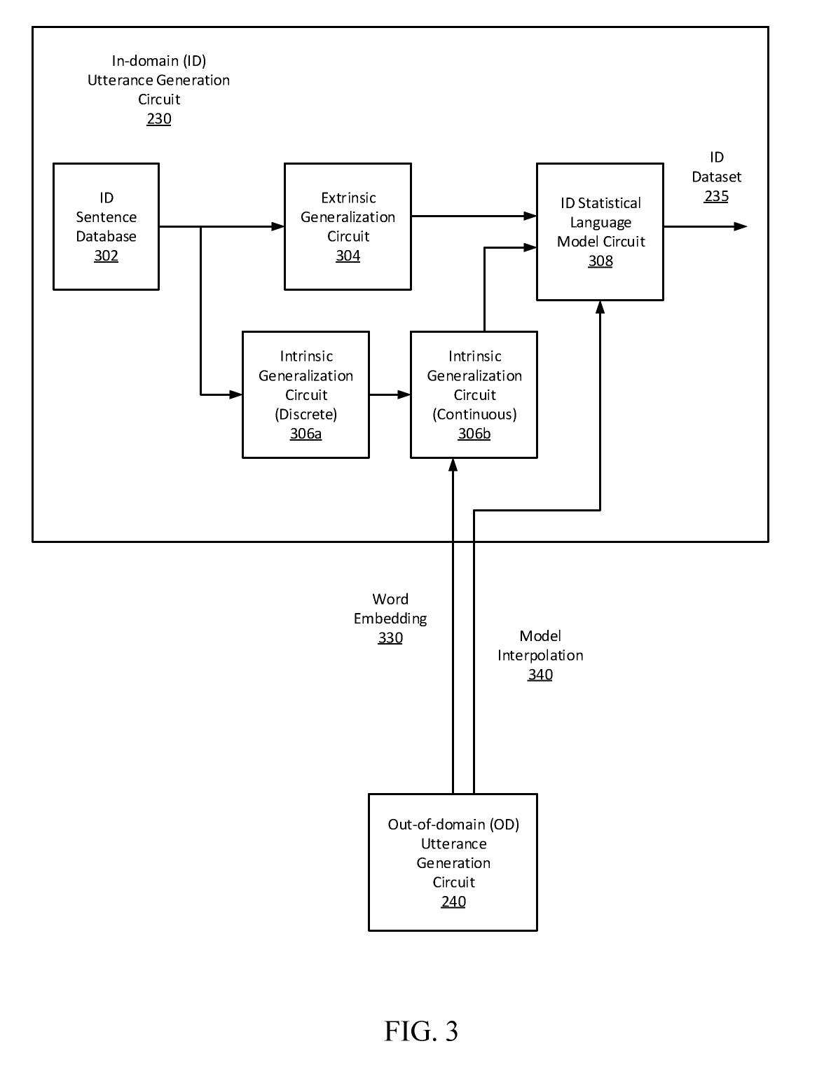

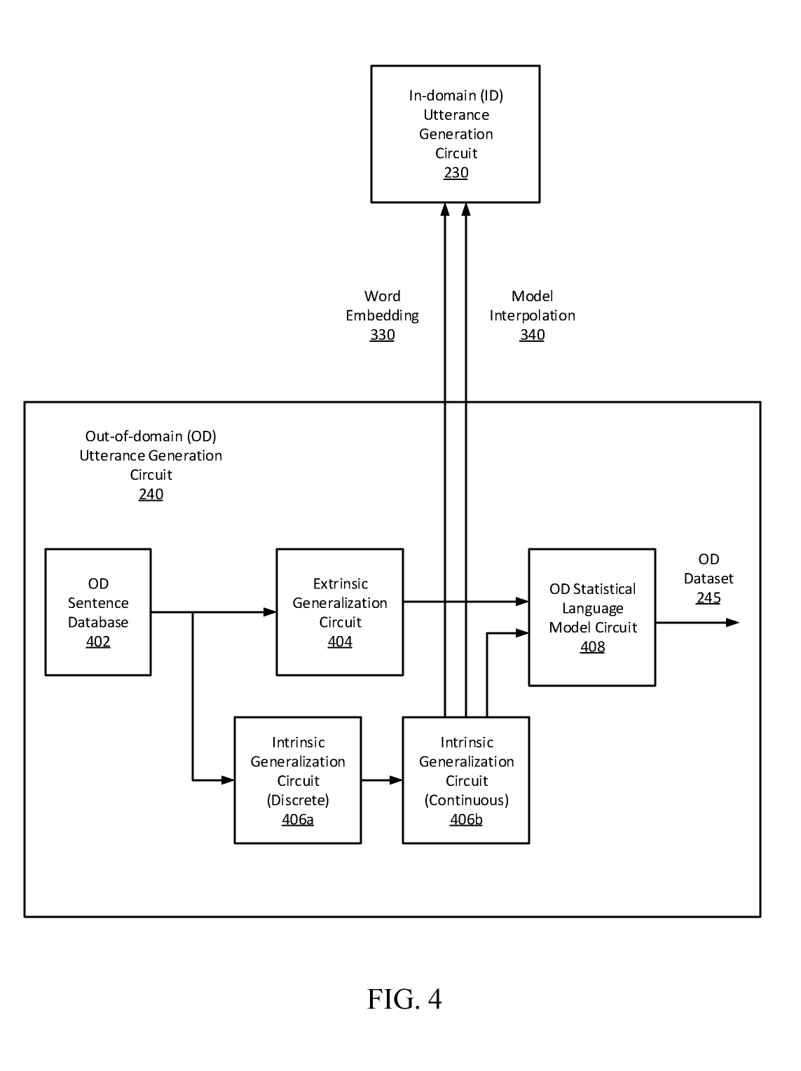

The ID/OD classifier 210 is configured to detect OD queries from the provided language input 120 which may include a mixture of ID and OD user queries. In some embodiments, the classifier may be implemented as a neural network. The classifier 210 generates labeled queries 130, from the language input 120, to be provided to the language-based application 140. The labels indicate that the query is either ID or OD. In some embodiments, the classifier 210, or another component of the query rejection system 100, may reject the detected OD queries so that they are not passed on to the application 140. In some further embodiments, the detected/rejected OD queries may be saved for later use (e.g., model tuning) associated with the ID and OD utterance generations and classifier training, which are described in greater detail below in connection with FIGS. 3 and 4.

In some embodiments, the query rejection system 100 may include a manual adjustment circuit 220 configured to allow a user or system developer to provide additional parameters such as, for example, average sentence length, average word probabilities, etc., for use by the utterance generation circuits 230, 240 described below.

In some embodiments, the query rejection system 100 may further include a user interface configured to allow the user to provide feedback associated with the results of the ID/OD classification. For example, the user may indicate that a previous query was correctly or incorrectly classified as ID or OD. Such feedback may then be used to adapt the training of the classifier during run-time in an iterative fashion, for example by updating the training utterances and sentences from an ID category to an OD category or vice versa.

FIG. 3 is a more detailed block diagram of the in-domain (ID) utterance generation circuit 230, configured in accordance with certain embodiments of the present disclosure. The ID utterance generation circuit 230 is shown to include an ID sentence database 302, an extrinsic generalization circuit 304, an intrinsic generalization circuit (discrete and continuous) 306a and 306b, and an ID statistical language model circuit 308. At a high level, the ID utterance generation circuit 230 is configured to generate a relatively large number of ID utterances to create an ID dataset 235 for use by the classifier training circuit 250. The ID utterances are based on variations of ID sentence examples, which may be provided by the ID sentence database 302 or another suitable source. It will be appreciated that the number of available ID sentence examples for any given application is typically small, and thus the automated generation of relatively large numbers of ID utterance variations is useful for training of the classifier 210.

The extrinsic generalization circuit 304 is configured to generate the variations of the ID sentences by substituting one or more words selected from the ID sentences with synonyms associated with those selected words. For example, the sentence “set volume to five” can be generalized to “set loudness to five,” “adjust volume to five,” and “adjust loudness to five.” The word substitutions are based on information from extrinsic knowledge sources such as, for example, a database, a thesaurus, or word ontologies.

The extrinsic generalization circuit 304 may further be configured to generate the variations by inserting a value into the ID sentences. The value is associated with properties of selected words of the ID sentences and is chosen from a pre-defined range of values. For example, the word “volume” can be associated with a “level” property that has a pre-defined range between zero and five, enabling the following sentences to be generated: “set volume to zero,” “set volume to one,” . . . “set volume to five.”

The extrinsic generalization circuit 304 may further be configured to generate the variations by inserting a phrase into the ID sentences. The phrase is generated based on rules, and probabilistic rules, for “part-of-speech” that specify where constructs such as “please” or “would you mind” may be added to sentences relative to nouns, verbs, etc. For example, “set volume to three” can be generalized to “please set volume to 3,” “would you mind setting the volume to three,” and “set the volume to three, please.”

The discrete intrinsic generalization circuit 306a is configured to recognize a class relationship between a first phrase in a first of the ID sentences and a second phrase in a second of the ID sentences. The recognition is based on predetermined rules and the variations are generated based on the class relationship. For example, a class may be used to represent numbers, colors, or other characteristics. In the case of a numeric class, an example first sentence is “set temperature to 65 degrees,” and an example second sentence is “50 degrees is just too cold.” From these sentences a class may be derived to represent a temperature value in degrees. The derived class may then be generalized to produce the following sentence variations: “set temperature to 65 degrees,” “set temperature to 50 degrees,” “65 degrees is just too cold,” and “50 degrees is just too cold.”

The continuous intrinsic generalization circuit 306b is configured to generate feature vectors for words of the ID sentences and perform a dimension reduction on the feature vectors. In some embodiments, the dimension reduction is based on one or more of the application of a neural network, the performance of principal component analysis, or the performance of linear discriminant analysis. A class relationship is then recognized between a first of the words and a second of the words, based on a distance measurement between the reduced dimension feature vectors. For example, the system learns that the words “one” and “three” are close together and probably assigned to a “level” property, based on the similarity or distance of the respective reduced dimension feature vectors. In contrast, the system learns that the words “light” and “climate” are more distant and likely to be in unrelated classes. In some embodiments, additional words (word embedding 330) may be provided by the OD utterance generation circuit 240 (described below) to provide additional training data for recognition of relationships, as some OD words may be as relevant as ID words for certain classes. Sentence variations are then generated based on the recognized class relationships, for example by interchanging words with sufficiently close class relationships as described previously in connection with discrete intrinsic generalization circuit 306a.

The ID statistical language model circuit 308 is configured to generate an ID dataset 235 based on calculated probabilities associated with the ID utterances generated by the extrinsic and intrinsic generalization circuits 304, 306 described above. For example, combinations of words with a relatively high probability can be used to generate sentences for the ID data set 235, while words or combinations of words with a relatively low probability will be rejected in forming the data set. The ID dataset 235 will include a relatively large number of words, for example in the range of a billion words or more. In some embodiments, the ID language model may be provided for direct use by downstream modules (e.g., the classifier training circuit 250) rather than or in addition to the generated sentences (the ID dataset 235). In some embodiments, the ID language model is implemented as a recurrent neural network or a Markov N-gram model. The ID language model is trained on the plurality of ID utterances (or on words, letters, or phoneme sequences derived from those utterances) that are provided by the generalization circuits 304, 306.

In some embodiments, the ID language model may be enhanced through model interpolation 340 with the OD language model (described below). Because the ID language model may be relatively sparse compared to the OD language model, this interpolation allows for smoothing of the probabilities of the ID language model.

FIG. 4 is a more detailed block diagram of the out-of-domain (OD) utterance generation circuit 240, configured in accordance with certain embodiments of the present disclosure. The OD utterance generation circuit 240 is shown to include an OD sentence database 402, and extrinsic generalization circuit 404, an intrinsic generalization circuit (discrete and continuous) 406a and 406b, and an OD statistical language model circuit 408. At a high level, the OD utterance generation circuit 240 is configured to generate a relatively large number of OD utterances to create an OD dataset 245 for use by the classifier training circuit 250. The OD utterances are based on variations of OD sentence examples, which may be provided by the OD sentence database 402 or another suitable source. The OD utterance generation circuit 240 and components 404, 406, 408 operate in a manner similar to the ID utterance generation circuit 230 described previously. In some embodiments, the OD and ID utterance generation circuits may share some or all of these components to some extent.

The extrinsic generalization circuit 404 is configured to generate the variations of the OD sentences by substituting one or more words selected from the OD sentences with synonyms associated with those selected words. The extrinsic generalization circuit 404 may further be configured to generate the variations by inserting a value into the OD sentences. The value is associated with properties of selected words of the OD sentences and is chosen from a pre-defined range of values. In some embodiments, the pre-defined range of values may be determined by analyzing relatively large volumes of available text data from any suitable source. The extrinsic generalization circuit 404 may further be configured to generate the variations by inserting a phrase into the OD sentences. The phrase is generated based on parts-of-speech rules and probabilistic rules.

The discrete intrinsic generalization circuit 406a is configured to recognize a class relationship between a first phrase in a first of the OD sentences and a second phrase in a second of the OD sentences. The recognition is based on predetermined rules and the variations are generated based on the class relationship.

The continuous intrinsic generalization circuit 406b is configured to generate feature vectors for words of the OD sentences and perform a dimension reduction on the feature vectors. In some embodiments, the dimension reduction is based on the application of a neural network, the performance of principal component analysis, or the performance of linear discriminant analysis. A class relationship is then recognized between a first of the words and a second of the words, based on a distance measurement between the reduced dimension feature vectors. Sentence variations are then generated based on the recognized class relationships, for example by interchanging words with sufficiently close class relationships as described previously in connection with discrete intrinsic generalization circuit 406a.

The OD statistical language model circuit 408 is configured to generate an OD dataset 245 based on calculated probabilities associated with the OD utterances generated by the extrinsic and intrinsic generalization circuits 404, 406 described above. For example, combinations of words with a relatively high probability will be used to generate sentences for the OD data set 245, while words or combinations of words with a relatively low probability will be rejected in forming the data set. The ID dataset 235 will include a relatively large number of words, for example in the range of a billion or more words. In some embodiments, the OD language model may be provided for direct use by downstream modules (e.g., the classifier training circuit 250) rather than or in addition to the generated sentences (the OD dataset 245). In some embodiments, the OD language model is implemented as a recurrent neural network or a Markov N-gram model. The OD language model is trained on the plurality of OD utterances (or on words, letters, or phoneme sequences derived from those utterances) that are provided by the generalization circuits 404, 406.

In some embodiments, the OD statistical language model circuit 408 may also be configured to insert random words to represent typical ASR insertion errors. This may improve the reliability of the classifier in the presence of ASR errors. Additionally, the probability threshold for word combinations may be set to a lower value for the OD statistical language model compared to the ID statistical language.

In some embodiments, OD queries that are rejected by the query rejection system 100 may be added to the OD sentence database 402 to improve the OD utterance generation process and provide greater variability (e.g., model tuning).

### Methodology

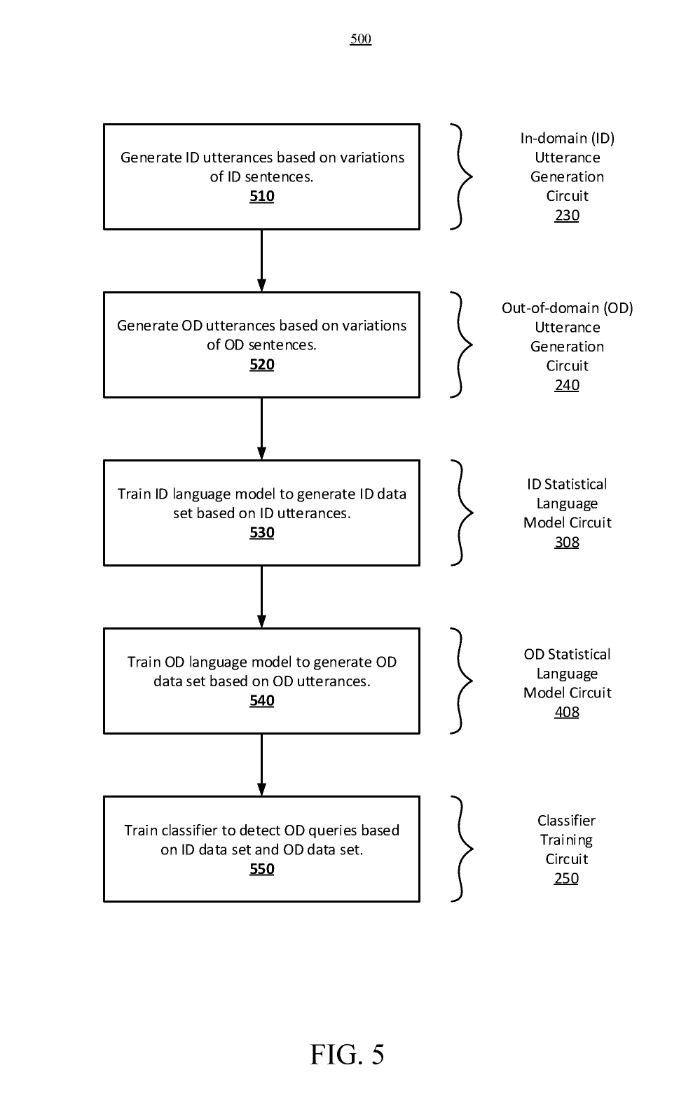

FIG. 5 is a flowchart illustrating an example method 500 for training a query rejection system to improve language understanding, in accordance with certain embodiments of the present disclosure. As can be seen, the example method includes a number of phases and sub-processes, the sequence of which may vary from one embodiment to another. However, when considered in the aggregate, these phases and sub-processes form a process for language understanding in accordance with certain of the embodiments disclosed herein. These embodiments can be implemented, for example using the system architecture illustrated in FIGS. 1-4 as described above. However other system architectures can be used in other embodiments, as will be apparent in light of this disclosure. To this end, the correlation of the various functions shown in FIG. 5 to the specific components illustrated in the other figures is not intended to imply any structural and/or use limitations. Rather, other embodiments may include, for example, varying degrees of integration wherein multiple functionalities are effectively performed by one system. For example, in an alternative embodiment a single module having decoupled sub-modules can be used to perform all of the functions of method 500. Thus, other embodiments may have fewer or more modules and/or sub-modules depending on the granularity of implementation. In still other embodiments, the methodology depicted can be implemented as a computer program product including one or more non-transitory machine readable mediums that when executed by one or more processors cause the methodology to be carried out. Numerous variations and alternative configurations will be apparent in light of this disclosure.

As illustrated in FIG. 5, in an embodiment, method 500 for detection of out-of-domain queries commences by generating, at operation 510, a plurality of in-domain (ID) utterances based on variations of one or more of a plurality of ID sentences. In some embodiments, the ID sentences may be provided from a database of task specific sentences or phrases. Next, at operation 520, a plurality of out-of-domain (OD) utterances are generated based on variations of one or more of a plurality of OD sentences. In some embodiments, the OD sentences may be provided from a database of sentences or phrases that are unrelated to the task or application of interest.

In some embodiments, the generation of utterance variations may be accomplished through substitution of selected words or word sequences of the ID and/or OD sentences with synonyms for those words or word sequences. The variations may also be generated by inserting values into the ID and/or OD sentences. The values are associated with properties of words of the sentences such as, for example, temperature or sound volume. The values may be selected from a pre-defined range of values for each property. The variations may also be generated by inserting phrases into the ID and/or OD sentences. The phrases are generated based on parts-of-speech rules and probabilistic rules. The variations may also be generated by recognizing and exploiting class relationships between a phrase in one sentence and a phrase in another sentence based on predetermined rules. In some embodiments, the class relationships may be recognized through dimension reduction of feature vectors of the sentences.

At operation 530, an ID statistical language model is trained based on the plurality of ID utterances. The ID language model is configured to generate an ID dataset based on calculated probabilities associated with the plurality of ID utterances. At operation 540, an OD statistical language model is trained based on the plurality of OD utterances. The OD language model is configured to generate an OD dataset based on calculated probabilities associated with the plurality of OD utterances. In some embodiments, the language models are implemented as a recurrent neural network or a Markov N-gram model.

At operation 550, a classifier is trained to detect OD queries from a received plurality of queries. The training is based on the ID dataset and the OD dataset. In some embodiments, the classifier may be a machine learning based classifier, such as, for example a neural network, support vector machine, or conditional random field.

Of course, in some embodiments, additional operations may be performed, as previously described in connection with the system. For example, detected OD queries may be rejected so that only ID queries are provided to a language-based application, resulting in improved language understanding.

### Example System

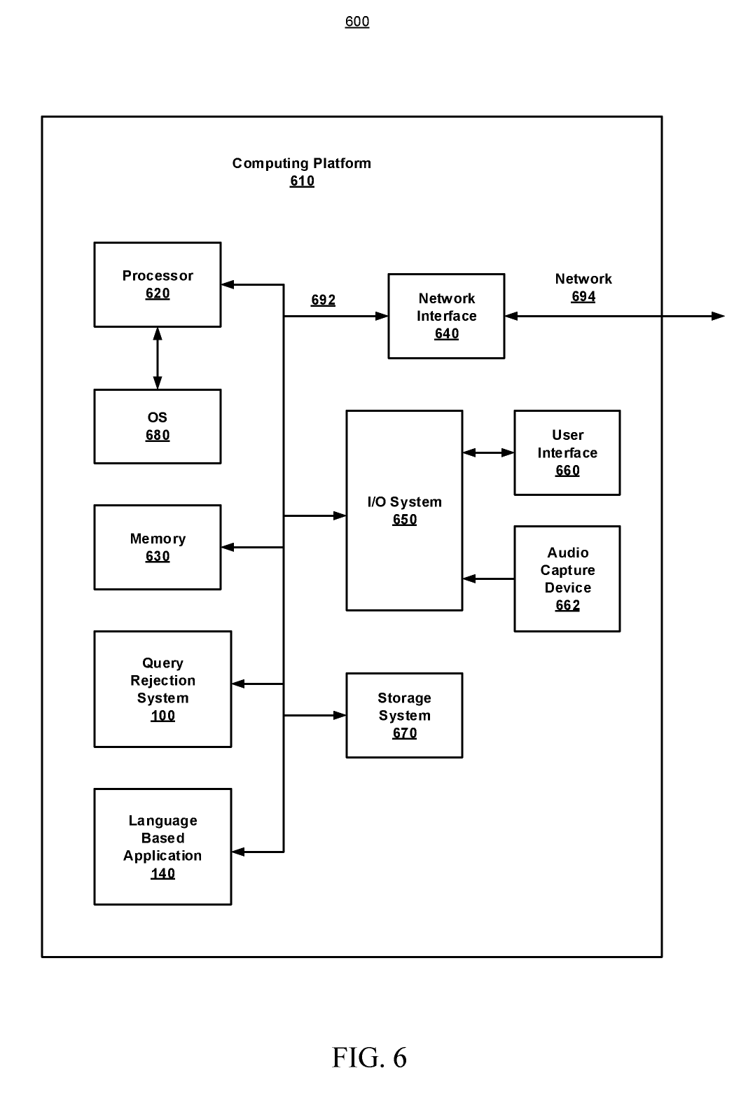

FIG. 6 illustrates an example system 600 to perform query rejection for improved language understanding, configured in accordance with certain embodiments of the present disclosure. In some embodiments, system 600 comprises a computing platform 610 which may host, or otherwise be incorporated into a personal computer, workstation, server system, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, imaging device, and so forth. Any combination of different devices may be used in certain embodiments.

In some embodiments, platform 610 may comprise any combination of a processor 620, a memory 630, query rejection system 100, and language-based application 140, a network interface 640, an input/output (I/O) system 650, a user interface 660, an audio capture device 662, and a storage system 670. As can be further seen, a bus and/or interconnect 692 is also provided to allow for communication between the various components listed above and/or other components not shown. Platform 610 can be coupled to a network 694 through network interface 640 to allow for communications with other computing devices, platforms, or resources. In some embodiments, network 694 may include the Internet. Other componentry and functionality not reflected in the block diagram of FIG. 6 will be apparent in light of this disclosure, and it will be appreciated that other embodiments are not limited to any particular hardware configuration.

Processor 620 can be any suitable processor, and may include one or more coprocessors or controllers, such as an audio processor, a graphics processing unit, or hardware accelerator, to assist in control and processing operations associated with system 600. In some embodiments, the processor 620 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 620 may be implemented as a complex instruction set computer (CISC) or a reduced instruction set computer (RISC) processor. In some embodiments, processor 620 may be configured as an x86 instruction set compatible processor.

Memory 630 can be implemented using any suitable type of digital storage including, for example, flash memory and/or random access memory (RAM). In some embodiments, the memory 630 may include various layers of memory hierarchy and/or memory caches as are known to those of skill in the art. Memory 630 may be implemented as a volatile memory device such as, but not limited to, a RAM, dynamic RAM (DRAM), or static RAM (SRAM) device. Storage system 670 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage 670 may comprise technology to increase the storage performance enhanced protection for valuable digital media when multiple hard drives are included.

Processor 620 may be configured to execute an Operating System (OS) 680 which may comprise any suitable operating system, such as Google Android (Google Inc., Mountain View, Calif.), Microsoft Windows (Microsoft Corp., Redmond, Wash.), Apple OS X (Apple Inc., Cupertino, Calif.), Linux, or a real-time operating system (RTOS). As will be appreciated in light of this disclosure, the techniques provided herein can be implemented without regard to the particular operating system provided in conjunction with system 600, and therefore may also be implemented using any suitable existing or subsequently-developed platform.

Network interface circuit 640 can be any appropriate network chip or chipset which allows for wired and/or wireless connection between other components of computer system 600 and/or network 694, thereby enabling system 600 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 650 may be configured to interface between various I/O devices and other components of computer system 600. I/O devices may include, but not be limited to, user interface 660 and audio capture device 662 (e.g., a microphone). User interface 660 may include devices (not shown) such as a display element, touchpad, keyboard, mouse, and speaker, etc. I/O system 650 may include a graphics subsystem configured to perform processing of images for rendering on a display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 620 or any chipset of platform 610.

It will be appreciated that in some embodiments, the various components of the system 600 may be combined or integrated in a system-on-a-chip (SoC) architecture. In some embodiments, the components may be hardware components, firmware components, software components or any suitable combination of hardware, firmware or software.

Query rejection system 100 is configured to detect and reject of out-of-domain queries using a classifier trained on generated in-domain and out-of-domain datasets, as described previously. Query rejection system 100 may include any or all of the circuits/components illustrated in FIGS. 2-4, as described above. These components can be implemented or otherwise used in conjunction with a variety of suitable software and/or hardware that is coupled to or that otherwise forms a part of platform 610. These components can additionally or alternatively be implemented or otherwise used in conjunction with user I/O devices that are capable of providing information to, and receiving information and commands from, a user.

In some embodiments, these circuits may be installed local to system 600, as shown in the example embodiment of FIG. 6. Alternatively, system 600 can be implemented in a client-server arrangement wherein at least some functionality associated with these circuits is provided to system 600 using an applet, such as a JavaScript applet, or other downloadable module or set of sub-modules. Such remotely accessible modules or sub-modules can be provisioned in real-time, in response to a request from a client computing system for access to a given server having resources that are of interest to the user of the client computing system. In such embodiments, the server can be local to network 694 or remotely coupled to network 694 by one or more other networks and/or communication channels. In some cases, access to resources on a given network or computing system may require credentials such as usernames, passwords, and/or compliance with any other suitable security mechanism.

In various embodiments, system 600 may be implemented as a wireless system, a wired system, or a combination of both. When implemented as a wireless system, system 600 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, system 600 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the out-of-domain query rejection methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 694. In other embodiments, the functionalities disclosed herein can be incorporated into other software applications, such as robotics, gaming, and virtual reality applications. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments system 600 may comprise additional, fewer, or alternative subcomponents as compared to those included in the example embodiment of FIG. 6.

The aforementioned non-transitory computer readable medium may be any suitable medium for storing digital information, such as a hard drive, a server, a flash memory, and/or random access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CR-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smart phones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is at least one non-transitory computer readable storage medium having instructions encoded thereon that, when executed by one or more processors, result in the following operations for training a classifier to detect out-of-domain queries. The operations comprise: generating a plurality of in-domain (ID) utterances based on variations of one or more of a plurality of ID sentences; generating a plurality of out-of-domain (OD) utterances based on variations of one or more of a plurality of OD sentences; generating an ID dataset based on calculated probabilities associated with the plurality of ID utterances; generating an OD dataset based on calculated probabilities associated with the plurality of OD utterances; training a classifier to detect OD queries from a received plurality of queries, the training based on the ID dataset and the OD dataset; and rejecting one or more of the detected OD queries.

Example 2 includes the subject matter of Example 1, wherein the classifier detection further includes a probability estimate associated with the detected OD query.

Example 3 includes the subject matter of Examples 1 or 2, the operations further comprising rejecting one or more of the detected OD queries and providing one or more non-rejected queries to a language-based application.

Example 4 includes the subject matter of any of Examples 1-3, the operations further comprising: generating the variations of the ID sentences by substituting one or more words selected from the ID sentences with synonyms associated with the selected words from the ID sentences; and generating the variations of the OD sentences by substituting one or more words selected from the OD sentences with synonyms associated with the selected words from the OD sentences.

Example 5 includes the subject matter of any of Examples 1-4, the operations further comprising generating the variations by inserting a value into the ID sentences or the OD sentences, the value associated with properties of words of the ID sentences or the OD sentences, the value selected from a pre-defined range of values.

Example 6 includes the subject matter of any of Examples 1-5, the operations further comprising generating the variations by inserting a phrase into the ID sentences or the OD sentences, the phrase generated based on parts-of-speech rules and probabilistic rules.

Example 7 includes the subject matter of any of Examples 1-6, the operations further comprising: recognizing a class relationship between a first phrase in a first sentence, of the ID sentences or the OD sentences, and a second phrase in a second sentence, of the ID sentences or the OD sentences, the recognition based on predetermined rules; and generating the variations based on the class relationship.

Example 8 includes the subject matter of any of Examples 1-7, the operations further comprising: generating feature vectors for words of the ID sentences and/or words of the OD sentences; performing dimension reduction of the feature vectors, the dimension reduction based on at least one of application of a neural network, principal component analysis, and linear discriminant analysis; recognizing a class relationship between a first of the words and a second of the words, the recognition based on the dimension reduced feature vectors; and generating the variations based on the class relationship.

Example 9 includes the subject matter of any of Examples 1-8, wherein at least one of: generating an ID dataset includes the operation of training an ID language model based on the plurality of ID utterances, the ID language model to generate the ID dataset based on calculated probabilities associated with the plurality of ID utterances; generating an OD dataset includes the operation of training an OD language model based on the plurality of OD utterances, the OD language model to generate an OD dataset based on calculated probabilities associated with the plurality of OD utterances; and the ID language model and the OD language model are implemented as at least one of a recurrent neural network or a Markov N-gram model.

Example 10 includes the subject matter of any of Examples 1-9, wherein the training of the ID language model is based on at least one of words, letters, and phoneme sequences derived from the plurality of ID utterances; and the training of the OD language model is based on at least one of words, letters, and phoneme sequences derived from the plurality of OD utterances.

Example 11 includes the subject matter of any of Examples 1-10, wherein the classifier detection is further based on at least one of an automatic speech recognition (ASR) confidence indicator, a language model score, and an acoustic model score.

Example 12 includes the subject matter of any of Examples 1-11, further comprising the operations of receiving user feedback associated with the classifier detection of previous user queries, and iteratively adapting the training of the classifier based on the feedback.

Example 13 is a system for training a classifier to detect out-of-domain queries. The system comprises: an in-domain (ID) utterance generation circuit to generate a plurality of ID utterances based on variations of one or more of a plurality of ID sentences; an out-of-domain (OD) utterance generation circuit to generate a plurality of OD utterances based on variations of one or more of a plurality of OD sentences; an ID language model circuit to generate an ID dataset based on calculated probabilities associated with the plurality of ID utterances; an OD language model circuit to generate an OD dataset based on calculated probabilities associated with the plurality of OD utterances; and a classifier training circuit to train a classifier to detect OD queries from a received plurality of queries, the training based on the ID dataset and the OD dataset.

Example 14 includes the subject matter of Example 13, wherein the classifier is further to generate a probability estimate associated with the detected OD query.

Example 15 includes the subject matter of Examples 13 or 14, wherein the classifier is further to reject one or more of the detected OD queries and provide one or more non-rejected queries to a language-based application.

Example 16 includes the subject matter of any of Examples 13-15, further comprising an extrinsic generalization circuit to: generate the variations of the ID sentences by substituting one or more words selected from the ID sentences with synonyms associated with the selected words from the ID sentences; and generate the variations of the OD sentences by substituting one or more words selected from the OD sentences with synonyms associated with the selected words from the OD sentences.

Example 17 includes the subject matter of any of Examples 13-16, further comprising an extrinsic generalization circuit to generate the variations by inserting a value into the ID sentences or the OD sentences, the value associated with properties of words of the ID sentences or the OD sentences, the value selected from a pre-defined range of values.

Example 18 includes the subject matter of any of Examples 13-17, further comprising an extrinsic generalization circuit to generate the variations by inserting a phrase into the ID sentences or the OD sentences, the phrase generated based on parts-of-speech rules and probabilistic rules.

Example 19 includes the subject matter of any of Examples 13-18, further comprising an intrinsic generalization circuit to: recognize a class relationship between a first phrase in a first sentence, of the ID sentences or the OD sentences, and a second phrase in a second sentence, of the ID sentences or the OD sentences, the recognition based on predetermined rules; and generate the variations based on the class relationship.

Example 20 includes the subject matter of any of Examples 13-19, further comprising an intrinsic generalization circuit to: generate feature vectors for words of the ID sentences and/or words of the OD sentences; perform dimension reduction of the feature vectors, the dimension reduction based on at least one of application of a neural network, principal component analysis, and linear discriminant analysis; recognize a class relationship between a first of the words and a second of the words, the recognition based on the dimension reduced feature vectors; and generate the variations based on the class relationship.

Example 21 includes the subject matter of any of Examples 13-20, wherein at least one of: the ID language model is trained on the plurality of ID utterances; the OD language model is trained on the plurality of OD utterances; and the ID language model and the OD language model are implemented as at least one of a recurrent neural network or a Markov N-gram model.

Example 22 includes the subject matter of any of Examples 13-21, wherein the training of the ID language model is based on at least one of words, letters, and phoneme sequences derived from the plurality of ID utterances; and the training of the OD language model is based on at least one of words, letters, and phoneme sequences derived from the plurality of OD utterances.

Example 23 includes the subject matter of any of Examples 13-22, wherein the classifier detection is further based on at least one of an automatic speech recognition (ASR) confidence indicator, a language model score, and an acoustic model score.

Example 24 includes the subject matter of any of Examples 13-23, wherein the classifier training circuit is further to receive user feedback associated with the classifier detection of previous user queries, and iteratively adapt the training of the classifier based on the feedback.

Example 25 is a processor-implemented method for training a classifier to detect out-of-domain queries, the method comprising: generating, by a processor-based system, a plurality of in-domain (ID) utterances based on variations of one or more of a plurality of ID sentences; generating, by the processor-based system, a plurality of out-of-domain (OD) utterances based on variations of one or more of a plurality of OD sentences; generating, by the processor-based system, an ID dataset based on calculated probabilities associated with the plurality of ID utterances; generating, by the processor-based system, an OD dataset based on calculated probabilities associated with the plurality of OD utterances; and training, by the processor-based system, a classifier to detect OD queries from a received plurality of queries, the training based on the ID dataset and the OD dataset.

Example 26 includes the subject matter of Example 25, wherein the classifier detection further includes a probability estimate associated with the detected OD query.

Example 27 includes the subject matter of Examples 25 or 26, further comprising rejecting one or more of the detected OD queries and providing one or more non-rejected queries to a language-based application.

Example 28 includes the subject matter of any of Examples 25-27, further comprising: generating the variations of the ID sentences by substituting one or more words selected from the ID sentences with synonyms associated with the selected words from the ID sentences; and generating the variations of the OD sentences by substituting one or more words selected from the OD sentences with synonyms associated with the selected words from the OD sentences.

Example 29 includes the subject matter of any of Examples 25-28, further comprising generating the variations by inserting a value into the ID sentences or the OD sentences, the value associated with properties of words of the ID sentences or the OD sentences, the value selected from a pre-defined range of values.

Example 30 includes the subject matter of any of Examples 25-29, further comprising generating the variations by inserting a phrase into the ID sentences or the OD sentences, the phrase generated based on parts-of-speech rules and probabilistic rules.

Example 31 includes the subject matter of any of Examples 25-30, further comprising: recognizing a class relationship between a first phrase in a first sentence, of the ID sentences or the OD sentences, and a second phrase in a second sentence, of the ID sentences or the OD sentences, the recognition based on predetermined rules; and generating the variations based on the class relationship.

Example 32 includes the subject matter of any of Examples 25-31, further comprising: generating feature vectors for words of the ID sentences and/or words of the OD sentences; performing dimension reduction of the feature vectors, the dimension reduction based on at least one of application of a neural network, principal component analysis, and linear discriminant analysis; recognizing a class relationship between a first of the words and a second of the words, the recognition based on the dimension reduced feature vectors; and generating the variations based on the class relationship.

Example 33 includes the subject matter of any of Examples 25-32, wherein at least one of: generating an ID dataset includes training an ID language model based on the plurality of ID utterances, the ID language model to generate the ID dataset based on calculated probabilities associated with the plurality of ID utterances; generating an OD dataset includes training an OD language model based on the plurality of OD utterances, the OD language model to generate an OD dataset based on calculated probabilities associated with the plurality of OD utterances; and the ID language model and the OD language model are implemented as at least one of a recurrent neural network or a Markov N-gram model.

Example 34 includes the subject matter of any of Examples 25-33, wherein the training of the ID language model is based on at least one of words, letters, and phoneme sequences derived from the plurality of ID utterances; and the training of the OD language model is based on at least one of words, letters, and phoneme sequences derived from the plurality of OD utterances.

Example 35 includes the subject matter of any of Examples 25-34, wherein the classifier detection is further based on at least one of an automatic speech recognition (ASR) confidence indicator, a language model score, and an acoustic model score.

Example 36 includes the subject matter of any of Examples 25-35, further comprising receiving user feedback associated with the classifier detection of previous user queries, and iteratively adapting the training of the classifier based on the feedback.

Example 37 is a system for training a classifier to detect out-of-domain queries, the system comprising: means for generating a plurality of in-domain (ID) utterances based on variations of one or more of a plurality of ID sentences; means for generating a plurality of out-of-domain (OD) utterances based on variations of one or more of a plurality of OD sentences; means for generating an ID dataset based on calculated probabilities associated with the plurality of ID utterances; means for generating an OD dataset based on calculated probabilities associated with the plurality of OD utterances; and means for training a classifier to detect OD queries from a received plurality of queries, the training based on the ID dataset and the OD dataset.

Example 38 includes the subject matter of Example 37, wherein the classifier detection further includes a probability estimate associated with the detected OD query.

Example 39 includes the subject matter of Examples 37 or 38, further comprising means for rejecting one or more of the detected OD queries and means for providing one or more non-rejected queries to a language-based application.

Example 40 includes the subject matter of any of Examples 37-39, further comprising: means for generating the variations of the ID sentences by substituting one or more words selected from the ID sentences with synonyms associated with the selected words from the ID sentences; and means for generating the variations of the OD sentences by substituting one or more words selected from the OD sentences with synonyms associated with the selected words from the OD sentences.

Example 41 includes the subject matter of any of Examples 37-40, further comprising means for generating the variations by inserting a value into the ID sentences or the OD sentences, the value associated with properties of words of the ID sentences or the OD sentences, the value selected from a pre-defined range of values.

Example 42 includes the subject matter of any of Examples 37-41, further comprising means for generating the variations by inserting a phrase into the ID sentences or the OD sentences, the phrase generated based on parts-of-speech rules and probabilistic rules.

Example 43 includes the subject matter of any of Examples 37-42, further comprising: means for recognizing a class relationship between a first phrase in a first sentence, of the ID sentences or the OD sentences, and a second phrase in a second sentence, of the ID sentences or the OD sentences, the recognition based on predetermined rules; and means for generating the variations based on the class relationship.

Example 44 includes the subject matter of any of Examples 37-43, further comprising: means for generating feature vectors for words of the ID sentences and/or words of the OD sentences; means for performing dimension reduction of the feature vectors, the dimension reduction based on at least one of application of a neural network, principal component analysis, and linear discriminant analysis; means for recognizing a class relationship between a first of the words and a second of the words, the recognition based on the dimension reduced feature vectors; and means for generating the variations based on the class relationship.

Example 45 includes the subject matter of any of Examples 37-44, wherein at least one of: generating an ID dataset includes means for training an ID language model based on the plurality of ID utterances, the ID language model to generate the ID dataset based on calculated probabilities associated with the plurality of ID utterances; generating an OD dataset includes means for training an OD language model based on the plurality of OD utterances, the OD language model to generate an OD dataset based on calculated probabilities associated with the plurality of OD utterances; and the ID language model and the OD language model are implemented as at least one of a recurrent neural network or a Markov N-gram model.

Example 46 includes the subject matter of any of Examples 37-45, wherein the training of the ID language model is based on at least one of words, letters, and phoneme sequences derived from the plurality of ID utterances; and the training of the OD language model is based on at least one of words, letters, and phoneme sequences derived from the plurality of OD utterances.

Example 47 includes the subject matter of any of Examples 37-46, wherein the classifier detection is further based on at least one of an automatic speech recognition (ASR) confidence indicator, a language model score, and an acoustic model score.

Example 48 includes the subject matter of any of Examples 37-47, further comprising means for receiving user feedback associated with the classifier detection of previous user queries, and means for iteratively adapting the training of the classifier based on the feedback.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not be this detailed description, but rather by the claims appended hereto. Future filed applications claiming priority to this application may claim the disclosed subject matter in a different manner, and may generally include any set of one or more elements as variously disclosed or otherwise demonstrated herein.

What is claimed is:

1. At least one non-transitory computer readable storage medium having instructions encoded thereon that, when executed by one or more processors, result in the following operations for training a classifier to detect out-of-domain queries, the operations comprising:
generating a plurality of in-domain (ID) utterances based on variations of one or more of a plurality of ID sentences;
generating a plurality of out-of-domain (OD) utterances based on variations of one or more of a plurality of OD sentences;
generating an ID dataset based on calculated probabilities associated with the plurality of ID utterances;
generating an OD dataset based on calculated probabilities associated with the plurality of OD utterances;
training a classifier to detect OD queries from a received plurality of queries, the training based on the ID dataset and the OD dataset; and
rejecting one or more of the detected OD queries.

2. The computer readable storage medium of claim 1, wherein the classifier detection further includes a probability estimate associated with the detected OD query.

3. The computer readable storage medium of claim 1, the operations further comprising rejecting one or more of the detected OD queries and providing one or more non-rejected queries to a language-based application.

4. The computer readable storage medium of claim 1, the operations further comprising:
generating the variations of the ID sentences by substituting one or more words selected from the ID sentences with synonyms associated with the selected words from the ID sentences; and
generating the variations of the OD sentences by substituting one or more words selected from the OD sentences with synonyms associated with the selected words from the OD sentences.

5. The computer readable storage medium of claim 1, the operations further comprising generating the variations by inserting a value into the ID sentences or the OD sentences, the value associated with properties of words of the ID sentences or the OD sentences, the value selected from a pre-defined range of values.

6. The computer readable storage medium of claim 1, the operations further comprising generating the variations by inserting a phrase into the ID sentences or the OD sentences, the phrase generated based on parts-of-speech rules and probabilistic rules.

7. The computer readable storage medium of claim 1, the operations further comprising:
recognizing a class relationship between a first phrase in a first sentence, of the ID sentences or the OD sentences, and a second phrase in a second sentence, of the ID sentences or the OD sentences, the recognition based on predetermined rules; and
generating the variations based on the class relationship.

8. The computer readable storage medium of claim 1, the operations further comprising:
generating feature vectors for words of the ID sentences and/or words of the OD sentences;
performing dimension reduction of the feature vectors, the dimension reduction based on at least one of application of a neural network, principal component analysis, and linear discriminant analysis;
recognizing a class relationship between a first of the words and a second of the words, the recognition based on the dimension reduced feature vectors; and
generating the variations based on the class relationship.

9. The computer readable storage medium of claim 1, wherein at least one of:
generating an ID dataset includes the operation of training an ID language model based on the plurality of ID utterances, the ID language model to generate the ID dataset based on calculated probabilities associated with the plurality of ID utterances;
generating an OD dataset includes the operation of training an OD language model based on the plurality of OD utterances, the OD language model to generate an OD dataset based on calculated probabilities associated with the plurality of OD utterances; and
the ID language model and the OD language model are implemented as at least one of a recurrent neural network or a Markov N-gram model.

10. The computer readable storage medium of claim 9, wherein the training of the ID language model is based on at least one of words, letters, and phoneme sequences derived from the plurality of ID utterances; and the training of the OD language model is based on at least one of words, letters, and phoneme sequences derived from the plurality of OD utterances.

11. The computer readable storage medium of claim 1, wherein the classifier detection is further based on at least one of an automatic speech recognition (ASR) confidence indicator, a language model score, and an acoustic model score.

12. The computer readable storage medium of claim 1, further comprising the operations of receiving user feedback associated with the classifier detection of previous user queries, and iteratively adapting the training of the classifier based on the feedback.

13. A system for training a classifier to detect out-of-domain queries, the system comprising:
an in-domain (ID) utterance generation circuit to generate a plurality of ID utterances based on variations of one or more of a plurality of ID sentences;
an out-of-domain (OD) utterance generation circuit to generate a plurality of OD utterances based on variations of one or more of a plurality of OD sentences;
an ID language model circuit to generate an ID dataset based on calculated probabilities associated with the plurality of ID utterances;
an OD language model circuit to generate an OD dataset based on calculated probabilities associated with the plurality of OD utterances; and
a classifier training circuit to train a classifier to detect OD queries from a received plurality of queries, the training based on the ID dataset and the OD dataset.

14. The system of claim 13, wherein the classifier is further to generate a probability estimate associated with the detected OD query.

15. The system of claim 13, wherein the classifier is further to reject one or more of the detected OD queries and provide one or more non-rejected queries to a language-based application.

16. The system of claim 13, further comprising an extrinsic generalization circuit to:
generate the variations of the ID sentences by substituting one or more words selected from the ID sentences with synonyms associated with the selected words from the ID sentences; and
generate the variations of the OD sentences by substituting one or more words selected from the OD sentences with synonyms associated with the selected words from the OD sentences.

17. The system of claim 13, further comprising an extrinsic generalization circuit to generate the variations by inserting a value into the ID sentences or the OD sentences, the value associated with properties of words of the ID sentences or the OD sentences, the value selected from a pre-defined range of values.

18. The system of claim 13, further comprising an extrinsic generalization circuit to generate the variations by inserting a phrase into the ID sentences or the OD sentences, the phrase generated based on parts-of-speech rules and probabilistic rules.

19. The system of claim 13, further comprising an intrinsic generalization circuit to:
recognize a class relationship between a first phrase in a first sentence, of the ID sentences or the OD sentences, and a second phrase in a second sentence, of the ID sentences or the OD sentences, the recognition based on predetermined rules; and
generate the variations based on the class relationship.

20. The system of claim 13, further comprising an intrinsic generalization circuit to:
generate feature vectors for words of the ID sentences and/or words of the OD sentences;
perform dimension reduction of the feature vectors, the dimension reduction based on at least one of application of a neural network, principal component analysis, and linear discriminant analysis;
recognize a class relationship between a first of the words and a second of the words, the recognition based on the dimension reduced feature vectors; and
generate the variations based on the class relationship.

21. The system of claim 13, wherein at least one of:
the ID language model is trained on the plurality of ID utterances;
the OD language model is trained on the plurality of OD utterances; and
the ID language model and the OD language model are implemented as at least one of a recurrent neural network or a Markov N-gram model.

22. The system of claim 21, wherein the training of the ID language model is based on at least one of words, letters, and phoneme sequences derived from the plurality of ID utterances; and the training of the OD language model is based on at least one of words, letters, and phoneme sequences derived from the plurality of OD utterances.

23. The system of claim 13, wherein the classifier detection is further based on at least one of an automatic speech recognition (ASR) confidence indicator, a language model score, and an acoustic model score.

24. The system of claim 13, wherein the classifier training circuit is further to receive user feedback associated with the classifier detection of previous user queries, and iteratively adapt the training of the classifier based on the feedback.

25. A processor-implemented method for training a classifier to detect out-of-domain queries, the method comprising:
generating, by a processor-based system, a plurality of in-domain (ID) utterances based on variations of one or more of a plurality of ID sentences;
generating, by the processor-based system, a plurality of out-of-domain (OD) utterances based on variations of one or more of a plurality of OD sentences;
generating, by the processor-based system, an ID dataset based on calculated probabilities associated with the plurality of ID utterances;
generating, by the processor-based system, an OD dataset based on calculated probabilities associated with the plurality of OD utterances; and
training, by the processor-based system, a classifier to detect OD queries from a received plurality of queries, the training based on the ID dataset and the OD dataset.
